(19) United States
(12) Patent Application Publication
(10) Pub. No.: US 2005/0043136 A1
(43) Pub. Date: Feb. 24, 2005

(54) Planetary gear system with welded one-piece double-helical gears

(76) Inventors: James Barry Colter, Mesa, AZ (US); Ronald Eugene Gilbert, Payson, AZ (US); Stephen C. Slaughter, Scottsdale, AZ (US); Michael James Havird, Mesa, AZ (US)

Correspondence Address: THOMPSON COBURN, LLP, ONE US BANK PLAZA, SUITE 3500, ST LOUIS, MO, 63101, US

(21) Appl. No.: 10/645,888

(22) Filed: Aug. 20, 2003

(51) Int. Cl. F16H 57/08

(52) U.S. Cl. 475/344

(57) ABSTRACT

A planetary gear system is provided where the sun and planet gears are of welded, one-piece double helical construction. Further provided is a method of forming a planetary gear system, and the sun and planet gears for such a system, by welding together two parts of the sun and planet gears, each part having helical gear teeth, to provide sun and planet gears of welded, one-piece double helical construction.

### BACKGROUND OF THE INVENTION

This invention is generally directed to a planetary gear system, and more particularly to such a gear system having welded, one piece, double-helical gears. The invention finds particular use in transmissions for rotocraft.

Typically, existing planetary systems in rotocraft transmissions use spur gears which generally have less load carrying capacity than helical planetary systems per a given gear face width. While a helical planetary system would have greater load carrying capacity per a given face width, the use of two-piece planets and/or sun gears in such systems requires the use of larger non-cylindrical bearings to handle the axial load separating forces created by the two-piece design. This axial load problem can be eliminated by the use of one-piece helical planets and sun gears which also provide an increased load carrying capacity over the conventional spur gear planetary configuration and allow use of cylindrical or spherical roller bearings for mounting the gears.

While one-piece double-helical gears have been used in planetary systems, the helical planet and sun gears have been machined using various techniques from a single work piece resulting in a relatively wide apex gap in the double-helical gear. This invention overcomes this problem by providing a planetary gear system where the sun and planet gears are of one-piece, double-helical construction formed by welding together the two helical portions of the gear and thereby allowing substantial reduction of the apex gap between the helical portions. Reduction of the apex gap increases the power density of the planetary drive system and when used in a transmission for a rotocraft contributes to savings of fuel, increased payload, greater range, and lower operating costs due to the reduction in weight resulting from the reduction in size of the apex gap.

### SUMMARY OF THE INVENTION

Generally, in accordance with the invention there is provided a planetary gear system having double-helical sun and planet gears, each double-helical gear formed from axially adjacent helical gear parts welded together to form a one-piece, double-helical gear. Further in accordance with the invention there is provided a single-piece, double-helical gear formed by welding together axially adjacent helical gear parts. Still further in accordance with the invention there is provided a method of forming a one-piece, double-helical gear comprising the step of welding together axially adjacent helical gear parts.

Further features and advantages of the present invention, as well as the structure and operation of various embodiments of the present invention, are described in detail below with reference to the accompanying drawings.

### BRIEF DESCRIPTION OF THE DRAWINGS

FIG. 1 is an exploded view of a planetary gear system illustrating a preferred embodiment of the present invention;

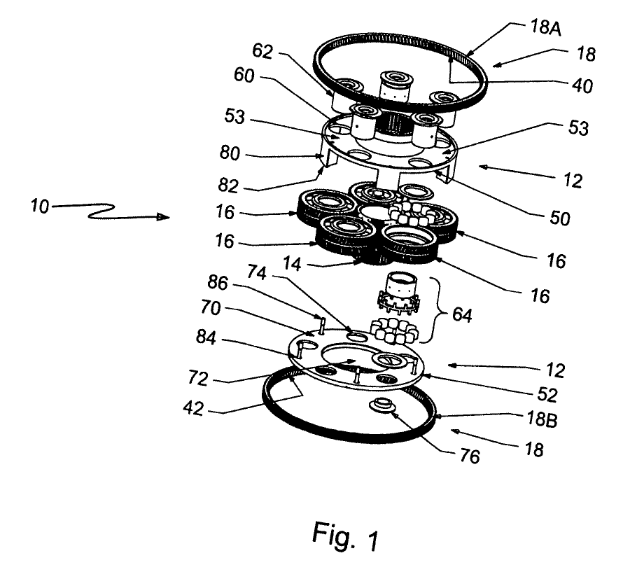

FIG. 2 is a perspective view illustrating a welded, one-piece double-helical sun gear of a preferred embodiment of the present invention;

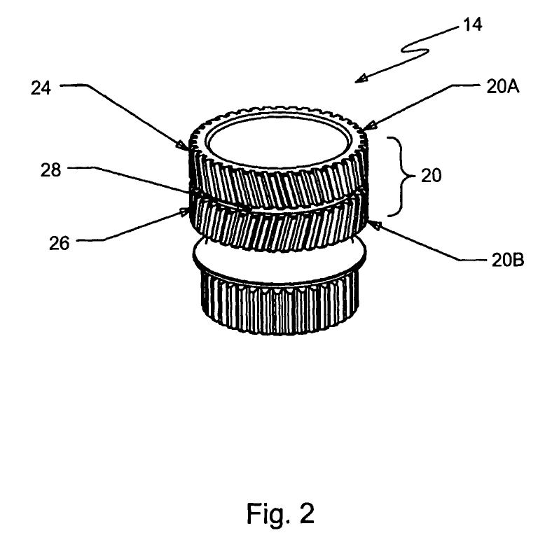

FIG. 3 is a perspective view of a welded, one-piece double-helical planet gear of a preferred embodiment of the present invention;

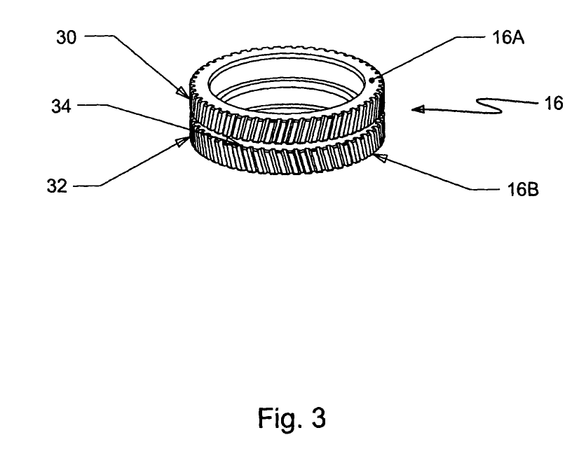

FIG. 4 is a perspective view of a partial assembly of the planetary gear system of FIG. 1 and the sun and planet gears of FIGS. 2 and 3; and

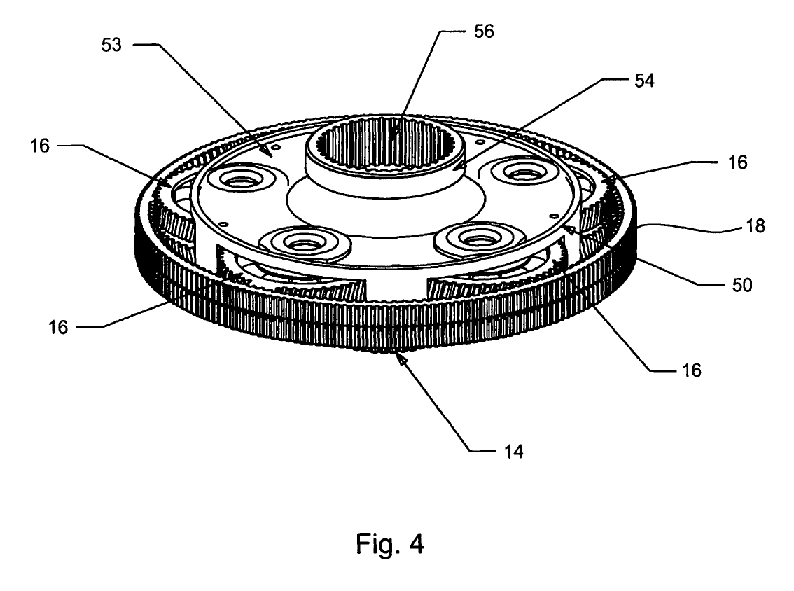

FIG. 5 is a schematic cross-section of a welded, one-piece double-helical planetary gear system in accordance with a preferred embodiment of the present invention.

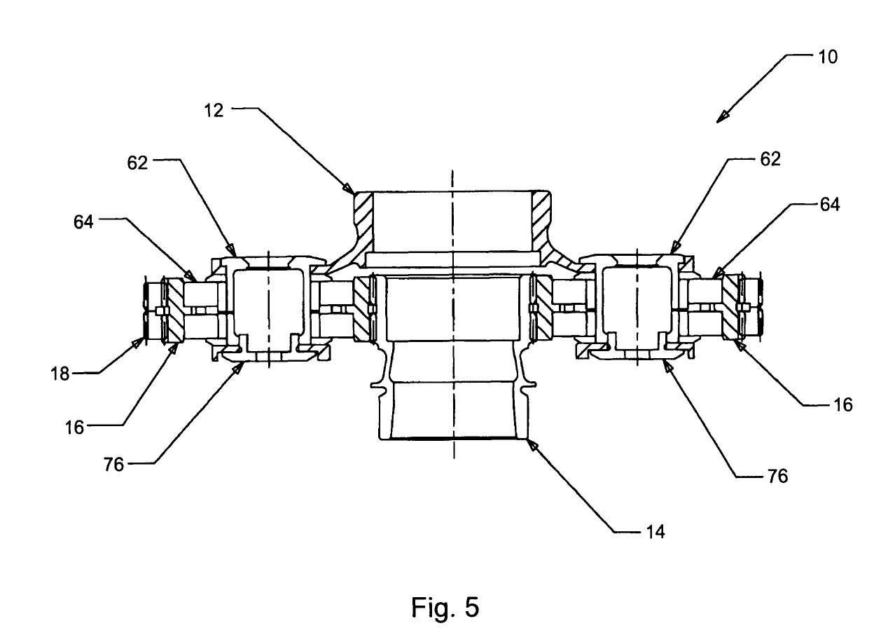

### DETAILED DESCRIPTION OF THE PREFERRED EMBODIMENT

With reference to the drawings there is shown a planetary gear system 10 of a preferred embodiment of the invention. The planetary gear system 10 includes a carrier 12, a sun gear assembly 14, a plurality of planet gears 16, and a ring gear 18. As will be further described, the sun gear 14 and each of the planet gears 16 is of a welded, one piece double-helical construction. The sun gear 14 has a double helical portion 20 comprising an upper helical gear 20A, with gear teeth 24, and a lower helical gear 20B, with gear teeth 26. An apex gap 28 is between the gear parts. The sun gear portion 20 is formed by welding the gear parts 20A and 20B together at the apex 28 with the gear parts coaxial and the helical teeth 24 and helical teeth 26 indexed to ensure the accuracy of the subsequent processing.

Each of the planet gears 16 comprises an upper helical gear 16A, with gear teeth 30, and a lower helical gear 16B, with gear teeth 32. An apex 34 is between the gear parts. As with the sun gear, each of the planet gears is formed by welding together the gear parts 16A and 16B at the apex 34 with the gear parts coaxial and the helical teeth 30 and helical teeth 32 indexed to ensure the accuracy of subsequent processing. In accordance with a preferred embodiment of the invention, the welding of the helical gear parts of the sun and planet gears is performed at the apex gaps 28 and 34 between the gear parts to minimize the gap width and thereby minimize the size and weight of the sun and planet gears, and thus the planetary gear system 10. In accordance with the preferred embodiment of the invention, the use of laser welding is preferred, but it is to be understood that other suitable types of welding may also be used.

The sun and planet gears are assembled with the carrier 12 such that the helical teeth of the gear parts of each of the plurality of planet gears meshes with the helical teeth of the gear parts of the sun gear. Also, the helical teeth of the gear parts of each planet gear meshes with the helical teeth of the ring gear 18. Moreover, preferably, the helical teeth of the sun gear and each of the planet gears are arranged such that with the sun and planet gears rotating about their respective axes, axial forces imparted against the helical teeth of one part of the gear are in direct opposition to the axial forces imparted against the helical teeth of the other part of the gear such that the net axial force is zero.

The ring gear 18 is of two-piece, helical construction to allow assembly of the system, and has upper ring gear half 18A having helical teeth 40 and lower ring gear half 18B having helical teeth 42. The helical teeth of the ring parts of the ring gear 18 mesh with the helical teeth of the gear parts of the planet gears as is typical of planetary gear systems.

The carrier 12 generally is comprised of two main components 50 and 52. The component 50 has a plate portion 53 with a central hub 54 with internal gear teeth 56, and a plurality of openings 60 in the plate portion surrounding the central hub. Each opening receives a spindle 62 on which a bearing assembly 64 is mounted for mounting a planet gear 16. The carrier component 52 has a ring portion 70 with a central opening 72 surrounded by openings 74 that receive spindle nuts 76 for axially securing the bearings. The component 50 also includes mounts 80 that have threaded openings 82 that align with corresponding openings 84 in the carrier component 52. The components 50 and 52 are secured together by bolts 86 that extend through the openings 84 and into the threaded openings 82, thereby rotatably securing the planet gears within the carrier. The sun gear extends into the central opening 72 with its helical gear teeth meshing with helical gear teeth of the planet gears. Although a two-piece carrier is described, it is to be understood that the carrier may be of one-piece construction or constructed of greater than two pieces as appropriate.

The welded, one-piece, double-helical construction of the invention is adaptable for use in conjunction with the Ausform finishing process used to shape the gear into the final form without any subsequent grinding of the teeth surfaces. This process is generally described in U.S. Pat. No. 6,126,892, incorporated herein by reference, issued to The Penn State Research Foundation.

The welded, one-piece, double-helical gear construction of this invention allows for the width of the gear face to be significantly less than that of a comparable double-helical gear of one-piece construction machined from a single work piece, while maintaining the same load carrying capacity. The welded, one-piece construction allows for minimizing the width of the apex gap, thereby significantly reducing the size and weight of the double-helical gears and the planetary gear system in which they are used. With the invention a significant increase in horsepower can be obtained while maintaining the same face width across the planet gear and the same pitch diameter of the ring gear. Because the double-helical gears are of a one-piece construction, the bearings for mounting the gears are only required to support radial loads as the axial load on the helical teeth of one gear part opposes the axial load on the gear teeth of the other gear part, thereby producing a net axial load of zero. The substantial weight and space savings without reduction of power density makes the planetary gear system of the invention particularly useful for the main transmissions of rotocraft (helicopters), but finds many other applications as well, particularly where size and weight are a factor.

While the present invention has been described by reference to specific embodiments and specific uses, it should be understood that other configurations and arrangements could be constructed, and different uses could be made, without departing from the scope of the invention as set forth in the following claims.

1. A planetary gear system comprising:
a sun gear adapted for rotation about a sun gear axis, the sun gear having a first sun gear part and a second sun gear part, the first sun gear part having first sun helical teeth, the second sun gear part having second sun helical teeth,
the first and second sun gear parts being coaxial and welded together such that the sun first and second helical teeth are axially adjacent,
a plurality of planet gears adapted for rotation about a corresponding plurality of planet gear axes, each planet gear comprising a first planet gear part and a second planet gear part, the first planet gear part of each planet gear having planet first helical teeth and the second planet gear part of each planet gear having planet second helical teeth,
the first and second planet gear parts of each planet gear being coaxial and welded together such that the planet first and second helical teeth are axially adjacent, and
the planet first helical teeth of each of the plurality of planet gears meshing with the sun first helical teeth, and the planet second helical teeth of each of the plurality of planet gears meshing with the sun second helical teeth.

2. The planetary gear system of claim 1 further comprising an apex gap between the first and second parts of the sun gear, and an apex gap between the first and second part of each of the planet gears.

3. The planetary gear system of claim 1 wherein the sun and planet helical teeth are arranged such that with the sun and planet gears rotating about their respective axes, axial forces imparted by the sun first helical teeth against the planet first helical teeth are in an axial direction opposite the axial forces imparted by the sun second helical teeth against the planet second helical teeth.

4. The planetary gear system of claim 1 wherein the sun first and second helical teeth are indexed, and the planet first and second helical teeth of each planet gear are indexed.

5. The planetary gear system of claim 1 wherein the welded sun and planet gears are shaped by Ausform finishing.

6. A double-helical gear comprising a first gear part and a second gear part, said first gear part having first helical teeth, and said second gear part having second helical teeth, said first and second gear parts being coaxial and welded together such that the first and second helical teeth are axially adjacent.

7. The double-helical gear of claim 6 wherein said gear is a sun gear of a planetary gear system.

8. The double-helical gear of claim 6 wherein said gear is a planet gear of a planetary gear system.

9. The double-helical gear of claim 6 wherein said first and second helical teeth are indexed.

10. The double-helical gear of claim 9 further comprising an apex gap between the first and second gear parts.

11. A method of forming a double-helical gear, said method comprising the steps of:
providing first and second helical gear parts, said first helical gear part having first helical teeth and said second gear part having second helical teeth, and
welding together said first and second parts with said first helical teeth axially adjacent said second helical teeth.

12. The method of claim 11 further comprising the step of shaping the welded gear using the Ausform finishing process.

13. The method of claim 11 further comprising the step of shaping the welded gear using the Ausform finishing process without any subsequent grinding of the teeth surfaces.

14. The method of claim 11 further comprising the step of welding together said first and second parts to provide an apex gap between the parts.

15. A method of forming a planetary gear system having one-piece, double-helical sun and planetary gears, said method comprising the steps of:
providing a sun gear adapted for rotation about a sun gear axis, the sun gear having a first sun gear part and a second sun gear part, the first sun gear part having first sun helical teeth, the second sun gear part having second sun helical teeth,
welding together the first and second sun gear parts with said parts coaxial and with the sun first and second helical teeth axially adjacent,
providing a plurality of planet gears adapted for rotation about a corresponding plurality of planet gear axes, each planet gear comprising a first planet gear part and a second planet gear part, the first planet gear part of each planet gear having planet first helical teeth and the second planet gear part of each planet gear having planet second helical teeth,
welding together the first and second planet gear parts of each planet gear with said parts coaxial and with the planet first and second helical teeth axially adjacent, and
meshing the planet first helical teeth of each of the plurality of planet gears with the sun first helical teeth, and meshing the planet second helical teeth of each of the plurality of planet gears with the sun second helical teeth.

16. The method of claim 15 further comprising the step of arranging the sun and planet helical teeth such that with the sun and planet gears rotating about their respective axes, axial forces imparted by the sun first helical teeth against the planet first helical teeth are in an axial direction opposite axial forces imparted by the sun second helical teeth against the planet second helical teeth.

17. The method of claim 16 further comprising the steps of:
providing a ring gear coaxial with the planet gears, the ring gear having a first ring gear part and a second ring gear part, the first ring gear part having ring first helical teeth and the second ring gear part having ring second helical teeth, and
meshing the ring first helical teeth with each of the planet first helical teeth and meshing the ring second helical teeth with each of the planet second helical teeth.

18. The method of claim 15 further comprising the steps of welding together the first and second sun gear parts to provide an apex gap between the parts, and welding together the first and second planet gear parts to provide an apex gap between the parts.
